(19) United States
(12) Patent Application Publication
(10) Pub. No.: US 2025/0354928 A1
(43) Pub. Date: Nov. 20, 2025

(54) CHARACTERISATION METHOD

(71) Applicant: KINGS COLLEGE LONDON, London, Greater London (GB)

(72) Inventor: Andrew James SURMAN, London (GB)

(73) Assignee: KINGS COLLEGE LONDON, London, Greater London (GB)

(21) Appl. No.: 18/861,192

(22) PCT Filed: Apr. 28, 2023
(86) PCT No.: PCT/GB2023/051135

§ 371 Date: Oct. 28, 2024

(30) Foreign Application Priority Data
Apr. 29, 2022 (GB) 2206324.2

(51) Int. Cl. G01N 21/64; B82Y 35/00; G01N 21/77

(52) U.S. Cl. CPC G01N 21/6428; B82Y 35/00; G01N 21/6452; G01N 21/77; G01N 2021/7786; G01N 2201/129

(57) ABSTRACT

This invention relates to a method for providing either quantitative or qualitative information on the composition of a nanomaterial, such as a graphene-based material, by contacting a plurality of portions of a sample of the nanomaterial with a plurality of responsive probes; measuring a property of each of the responsive probes in the presence of the nanomaterial to provide a plurality of property measurements; and processing the plurality of property measurements in order to provide the qualitative or quantitative information. The invention also relates to a kit for carrying out the aforementioned method.

This invention relates to a method for providing information on the composition of a nanomaterial (e.g. a graphene-based material) that utilises an array of responsive probes.

### BACKGROUND

“Graphene-based materials” (GBMs), such as Graphene Oxide (GO), samples contain flakes having a particular profile of different lateral dimensions, numbers of layers, defects and degrees and types of functionalisation. Different production methods result in samples having different profiles and therefore different properties (P. Bøggild, Nature, 2018, 562, 502).

Anecdote has long suggested samples (sold under the same label; “graphene”, “graphene oxide”, etc) vary wildly between manufacturers and even batches from the same manufacturer. In a study the structure of “graphene” from >60 commercial sources was analysed to establish the scale of the problem. Few were predominantly single-layer graphene; many varied wildly in size, % sp²-hybridised carbon, and number of layers. Some even contained less than 60% carbon (A. P. Kauling, A. T. Seefeldt, D. P. Pisoni, R. C. Pradeep, R. Bentini, R. V. B. Oliveira, K. S. Novoselov and A. H. C. Neto, Advanced Materials, 2018, 30, 1803784). This lack of reproducibility is an impediment to realising graphene/GBM's promise.

International standards (ISO) for graphene are now appearing (ISO/TS 21356-1. Nanotechnologies—Structural characterization of graphene—Part 1: Graphene from powders and dispersions, 2021), but still lacking for other GBMs (e.g. GO). ‘Gold standard’ structural and chemical characterisation is context-dependent (National Physical Lab, Good Practice Guide No. 145: Characterisation of the Structure of Graphene) tending to employ SEM, TEM, AFM, XPS, Raman spectroscopy, and elemental analysis in combination. These are expensive, time-consuming, and require sample preparation, data interpretation, expertise & specialist instruments. This inaccessibility is manifest in how long it has taken for a large-scale survey of graphene supplies to be attempted, despite broad community concern.

Ideal QC methods provide sufficient information for decisions cheaply, quickly, with little infrastructure required, and are readily performed at technician level. Dispersion methods are attractive, given nanomaterial powder handling safety concerns.

Some approaches are being considered, all with issues. Dynamic light scattering (DLS) sizing is available and quick but ill-suited to non-spherical species and reproducibility can be an issue in non-specialist settings. Gas adsorption (BET) complements detailed characterisation, but is limited to surface area measurement. Electrochemical methods have been mooted, but so far made little progress.

It is an aim of certain embodiments of the present invention to overcome certain problems, such as those mentioned above, associated with GBM characterisation and nanomaterial characterisation in general.

### BRIEF SUMMARY OF THE DISCLOSURE

In accordance with the first aspect of the invention is provided a method for providing information on the composition of a nanomaterial (e.g. a graphene-based material (GBM)), the method comprising:
contacting a plurality of portions of a sample of the nanomaterial with a plurality of responsive probes;
measuring a property of each of the responsive probes in the presence of the nanomaterial to provide a plurality of property measurements; and
processing the plurality of property measurements in order to provide either qualitative or quantitative information on the composition of the nanomaterial.

In an embodiment, the method comprises:
contacting a plurality of portions of at least two samples of the nanomaterial with a plurality of responsive probes;
measuring a property of each of the responsive probes in the presence of the at least two samples of the nanomaterial to provide a plurality of property measurements; and
processing the plurality of property measurements in order to provide either qualitative or quantitative information on the composition of at least one of the samples of the at least two samples of the nanomaterial. The at least two samples may be at least three samples (e.g. at least four, or at least five samples).

### Probes

Typically, when contacting the plurality of portions of the sample of the nanomaterial (e.g. GBM) with the plurality of responsive probes, each portion of the nanomaterial sample is contacted with a probe of a single identity. However, it may be that at least one portion of the nanomaterial (e.g. GBM) sample is contacted with a plurality of responsive probes with different identities, e.g. it may be that each portion of the nanomaterial sample is contacted with a plurality of responsive probes with different identities.

It may be that the responsive probes are spectroscopic probes. The spectroscopic probes may be infrared (IR) probes, ultraviolet-visible (UV/Vis) probes, nuclear magnetic resonance (NMR) probes, Raman probes, X-Ray probes or fluorescent probes. It may be that the responsive probes are UV-Vis probes. It may be that the responsive probes are fluorescent probes. It may be that the responsive probes are electrochemical probes.

The identity of the responsive probes used will determine the measured property of each of the responsive probes in the presence of the nanomaterial (e.g. GBM). Based on the responsive probes used, the person skilled in the art will understand what property to measure. If spectroscopic probes are used, then the measured property will be the spectroscopic property associated with those spectroscopic probes. For example, if the responsive probes are fluorescent probes then the property to be measured of the fluorescent probes in the presence of the nanomaterial will be fluorescence. It may be that the property measured is the intensity of fluorescence at a particular wavelength. If the responsive probes are UV-Vis probes then the property to be measured of the probes in the presence of the nanomaterial will be the absorbance and/or emission of light in the UV-visible range. It may be that the property measured is the intensity of UV-visible light absorbed or emitted at a particular wavelength. The measured wavelength of each portion of the sample may be different. This will depend on the probe being tested. It may be that more than one wavelength is measured for each portion.

Spectroscopic properties, e.g. fluorescence or UV/Vis, can be measured by techniques well known in the art. Recent technology has seen smart devices being used to measure electromagnetic, e.g. ultraviolet, radiation. It may be therefore that the spectroscopic properties, e.g. fluorescence or UV/Vis, of the responsive probes in the presence of the nanomaterial are measured by capturing or photographing the responsive probes in the presence of the nanomaterial via the camera of a smart device, e.g. a smart phone, and processing the captured or photographed image to provide the plurality of property measurements. The captured or photographed image may be processes by a fog network.

If the responsive probes are electrochemical probes, then the electrochemical properties of the electrochemical probes in the presence of the nanomaterial will be measured. Electrochemical properties, e.g. electrochemical potential or electrochemical impedance, can be measured by techniques well known in the art.

It may be that at least one of the responsive probes does not form covalent bonds with the nanomaterial. It may be that none of the responsive probes form covalent bonds with the nanomaterial.

It may be that the plurality of responsive probes consists of 2 or more probes. It may be that the plurality of responsive probes consists of 3 or more probes. It may be that the plurality of responsive probes consists of 4 or more probes. It may be that the plurality of responsive probes consists of 5 or more probes.

The responsive probes may be fluorescent probes. In embodiments where the responsive probes are fluorescent probes, the probes will typically comprise a plurality of (e.g. at least 3) aromatic or heteroaromatic rings. The array of probes may comprise an amphiphilic probe. It may be that the array of probes comprises a probe comprising an aromatic moiety and a charged or dipolar moiety. The aromatic moiety may comprise a plurality of (e.g. at least 3) fused aromatic or heteroaromatic rings, e.g. pyrene. The charged moiety may be a sulphate, phosphate, diphosphate, quaternary ammonium cation, acetate or nitrate. It may be that the charged moiety is a sulphate, phosphate or quaternary ammonium cation. It will be appreciated that prior to contacting the plurality of portions of a sample of the nanomaterial (e.g. the GBM) with a plurality of responsive probes having a charged moiety, said probes may be in the form of a salt. The aforementioned charged moieties may therefore be paired with a suitable counterion, e.g. a sodium or bromide counterion. The probe may further comprise a hydrocarbon spacer linking the aromatic moiety to the charged or dipolar moiety. It may be that the hydrocarbon spacer is an alkylene, e.g. C₁-C₆-alkylene, optionally substituted where chemically possible with 1 to 4 substituents independently selected from halo, OH and C₁-C₄-alkyl. It may be that the hydrocarbon spacer is an alkylene, e.g. C₁-C₆-alkylene, substituted where chemically possible with 1 to 4 OH groups. It may be that each probe in the array of probes is as defined above.

The plurality of probes may comprise at least one probe selected from:

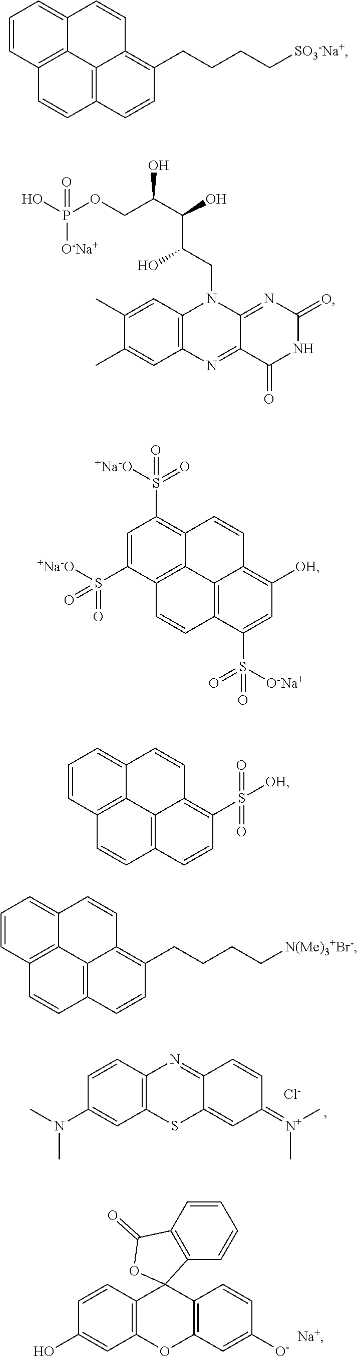

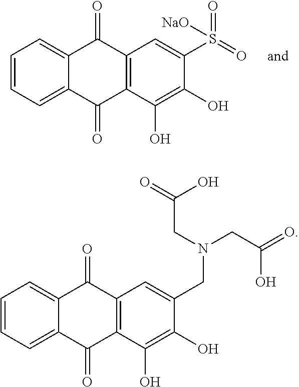

The plurality of probes may comprise any two or more probes selected from:

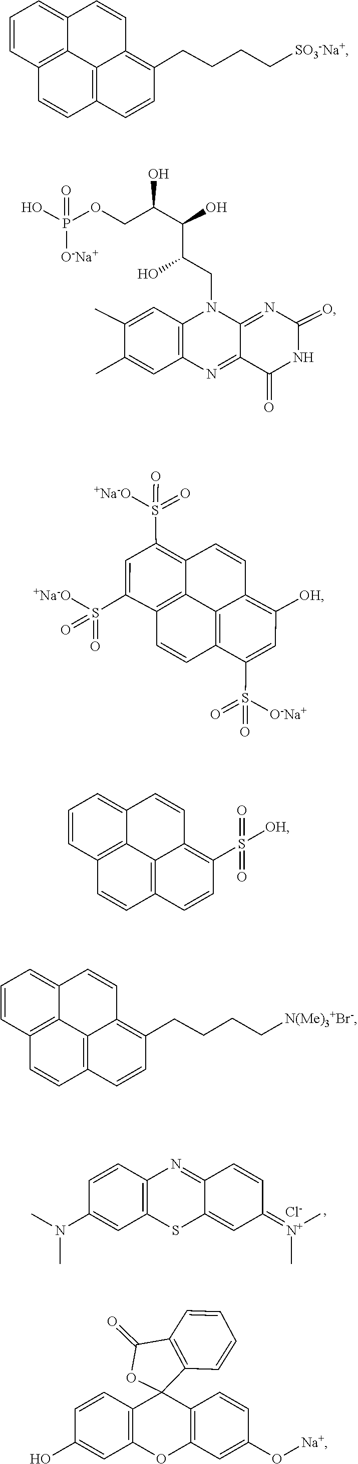

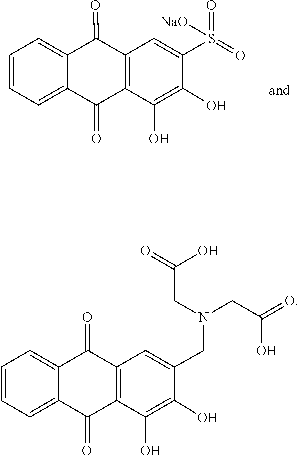

The plurality of probes may comprise at least one probe selected from:

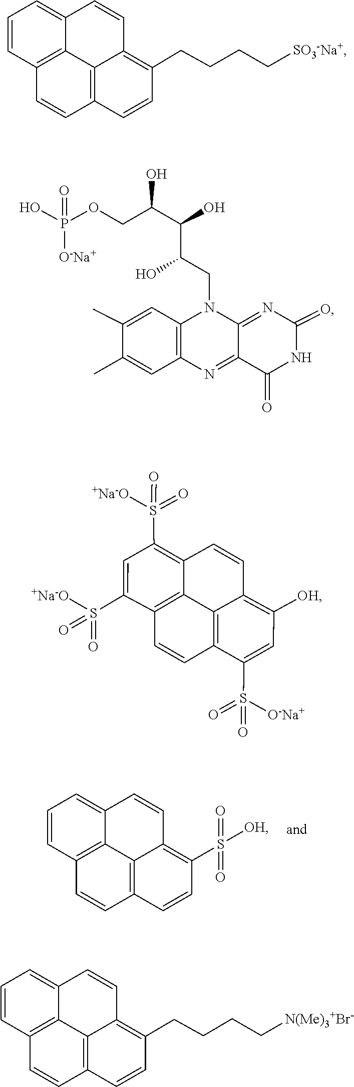

The array of probes may comprise any two or more probes selected from:

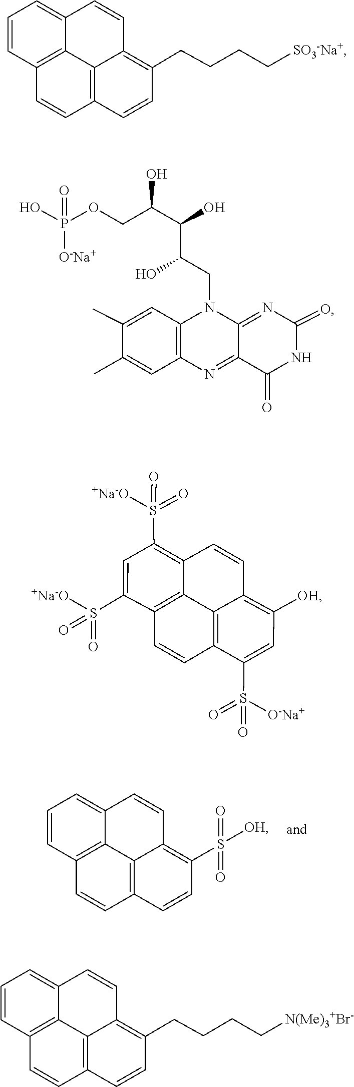

The above probes are illustrative floursecent probes.

Macromolecular probes, such as polymeric probes, conjugated polymer probes and biopolymeric probes, 2D nanomaterial probes (e.g. fluorescent carbon dots) and metal complex probes may also be used in the method of the invention.

### Nanomaterial

In some embodiments, the nanomaterial is a 2D nanomaterial, i.e. a nanosheet. The 2D nanomaterial may be a graphene-based material (GBM), e.g. graphene. The graphene may be pristine graphene, graphene oxide, reduced graphene oxide, functionalised graphene or graphene nanoplatelets. The graphene may be graphene oxide or reduced graphene oxide. The graphene may be graphene oxide.

A single molecular layer of graphene is one atom thick and can therefore be described as a single atomic layer (“layer”). Typically, graphene will have an average thickness of <10 layers. The graphene may be single layer graphene. The graphene may be multilayer graphene. The graphene may have an average thickness of between 1-3 layers, e.g. 1-5 layers. The graphene may have an average thickness of >5 layers.

The 2D nanomaterial may be graphyne or a 2D polymer, e.g. a crystalline 2D polymer.

The 2D nanomaterial may be a non-carbon-containing 2D material. Illustrative non-carbon-containing 2D materials include borophene, germanene, silicene, stanine, plumbene, phosphorene, antimonene, bismuthine, transition metal dichalcogenides (TMDCs), hexagonal boron nitride (h-BN), black phosphorus (BP), and 2D metal oxides.

In some embodiments, the nanomaterial is a 1D nanomaterial, e.g. nanotubes, nanowires and nanorods. The 1D nanomaterial may be carbon nanotubes. The carbon nanotubes may be single-wall or multi wall carbon nanotubes. The carbon nanotubes may be pristine or functionalized carbon nanotubes. For example, the carbon nanotubes may be carbon-nanotubes functionalised with metal, halogens or organic functional groups. The 1D nanomaterial may be graphene nanoribbon or carbon nanobuds.

In some embodiments, the nanomaterial is a 0D nanomaterial, e.g. a quantum dot. The 0D nanomaterial may be a carbon-containing 0D nanomaterial, e.g. carbon nanodots and closed fullerenes. The closed fullerene may be buckminsterfullerene.

### Portions

The portions of the sample of the nanomaterial (e.g. the GBM) may be dispersions of the nanomaterial. It may be that the dispersions are aqueous dispersions. It may be that the dispersions are dispersions in an organic solvent. The organic solvent may be selected from the group consisting of an ether, methanol, ethanol, chloroform, tetrachloromethane, benzene, tetrahydrofuran, dimethyl acetamide, N-Methyl-2-pyrrolidone and DMSO. It may be that the dispersions are formed by sonicating the nanomaterial (e.g. GBM) in a solvent, e.g. water or the aforementioned organic solvents. It may be that the dispersions are formed by sonicating the nanomaterial (e.g. GBM) in a solvent for <60 s, e.g. from between 10 and 50 s.

The step of contacting a plurality of portions of a sample of the nanomaterial (e.g. GBM) with a plurality of responsive probes may therefore comprise adding a plurality of responsive probes to a plurality of dispersions of a sample of the nanomaterial.

The concentration of nanomaterial (e.g. GBM) in the dispersion may be equal to or less than 0.5 mg/ml, e.g. equal to or less than 0.2 mg/mL. The concentration of nanomaterial in the dispersion may be from 0.07 to 0.13 mg/mL. The concentration of nanomaterial in the dispersion may be equal to or less than 0.1 mg/mL, e.g. equal to or less than 0.05 mg/mL. The concentration of nanomaterial in the dispersion may be equal to or less than 0.02 mg/mL.

After adding a plurality of responsive probes to a plurality of dispersions of a sample of the nanomaterial (e.g. GBM), the concentration of the probe in the dispersion may be equal to or less than 0.5 mg/mL, e.g. equal to or less than 0.2 mg/mL. The concentration of the probe in the dispersion may be from 0.07 to 0.13 mg/mL. The concentration of the probe in the dispersion may be from 0.05 to 0.15 mM.

The dispersions may comprise a buffer. The buffer may be a phosphate buffer. The buffer may be a neutral buffer. The buffer may maintain the pH of the dispersion in the range from 6 to 8, e.g. from 6.5 to 7.5.

It may be that the pH of the dispersions are in the range from 6 to 8, e.g. from 6.5 to 7.5. It may be that the pH of the dispersions are about 7.0.

It may be that the dispersions comprise a total ionic strength adjustment buffer (TISAB).

The inventors have found that certain dispersion conditions, e.g. pH, ionic strength, probe concentration, dispersion solvent, number of probe identities per dispersion and the presence of a non-responsive competing binder, influence the interaction of the responsive probes with the nanomaterial (e.g. GBM). Therefore, varying such dispersion conditions (e.g. pH and/or ionic strength) may allow information on the composition of the nanomaterial to be more easily acquired.

Thus, it may be that two or more dispersions vary in at least one condition selected from:
i) the concentration of the nanomaterial (e.g. GBM);
ii) the concentration of the responsive probe;
iii) the solvent of the dispersion;
iv) the pH of the dispersion;
v) the ionic strength of the dispersion; and/or
vi) the absence or presence of a non-responsive competing binder, and, if present, optionally the concentration of the non-responsive competing binder.

It may be that each dispersion varies in at least one condition selected from:
i) the concentration of the nanomaterial (e.g. GBM);
ii) the concentration of the responsive probe;
iii) the solvent of the dispersion;
iv) the pH of the dispersion;
v) the ionic strength of the dispersion; and/or
vi) the absence or presence of a non-responsive competing binder, and, if present, optionally the concentration of the non-responsive competing binder.

It may be that at least two of the dispersions differ in the identity of the responsive probe and at least two of the dispersions differ in at least one condition selected from i) to vi). It may be that each solution differs in the identity of the responsive probe and each solution differs in at least one condition selected from i) to vi). It may be that each dispersion comprises a responsive probe of the same identity and at least two of the dispersions differ in at least one condition selected from i) to vi). It may be that each dispersion comprises a responsive probe of the same identity and each dispersions differs in at least one condition selected from i) to vi).

It may be that two or more portions (e.g. dispersions) of the sample of nanomaterial are contacted with probes of the same identity but have different pHs and/or ionic strengths. It may be that at least two of the dispersions do not differ in the identity of the responsive probe but have different pHs. It may be that none of the dispersions differ in the identity of the responsive probe but each dispersion has a different pH. It may be that the pH of the dispersions are each independently selected to be in the range from 6 to 8, e.g. from 6.5 to 7.5. At least one of the dispersions (e.g. each dispersion) may comprise a buffer. The buffer may be a phosphate buffer. The buffer may be a neutral buffer. The buffer may maintain the pH of the dispersion in the range from 6 to 8, e.g. from 6.5 to 7.5.

It may be that at least one of the dispersions comprise two responsive probes having different identities.

It may be that the dispersions comprise dispersion A and dispersion B, wherein dispersion A comprises two responsive probes having different identities and dispersion B comprises two responsive probes having different identities. It may be that one of the responsive probes in dispersion A has the same identity as one of the responsive probes in dispersion B (and the other responsive probe in dispersion A has a different identity to the other responsive probe in dispersion B). Alternatively, it may be that neither of the responsive probes in dispersion A have the same identity of either of the responsive probes in dispersion B.

It may be that at least one of the dispersions comprises a non-responsive competing binder. It may be that the dispersions comprise dispersion C and dispersion D, wherein dispersion C comprises a responsive probe and dispersion D comprises a responsive probe having the same identity as the probe in dispersion C and a non-responsive competing binder. It may be that the dispersions comprise dispersion E and dispersion F, wherein dispersion E comprises a probe and a non-responsive competing binder and dispersion F comprises a probe having a different identity to the probe in dispersion E and a non-responsive competing binder having the same identity as the non-responsive competing binder in dispersion E.

Typically, after contacting the plurality of portions of the sample of the nanomaterial with the plurality of responsive probes, the plurality of portions of the sample of the nanomaterial are not washed before measuring the property of each of the responsive probes in the presence of the nanomaterial (and, e.g. may remain in dispersion).

It may be that when measuring the property of each of the responsive probes in the presence of the nanomaterial some of the responsive probes will not interact with the nanomaterial.

It may be that the method comprises measuring the property of each of the responsive probes in the presence of the nanomaterial to provide a plurality of property measurements within less than 1 h of contacting the plurality of portions of a sample of the nanomaterial with the plurality of responsive probes. It may be that the method comprises measuring the property of each of the responsive probes in the presence of the nanomaterial to provide a plurality of property measurements within less than 30 minutes (e.g. less than 15 minutes) of contacting the plurality of portions of the sample of the nanomaterial with a plurality of responsive probes. Typically, the method comprises measuring the property of each of the responsive probes in the presence of the nanomaterial to provide a plurality of property measurements within from between 5 and 15 minutes of contacting the plurality of portions of the sample of the nanomaterial with a plurality of responsive probes.

### Processing Property Measurements

It may be that processing the plurality of property measurements in order to provide either qualitative or quantitative information on the composition of the nanomaterial (e.g. GBM) consists of deconvoluting the plurality of property measurements in order to provide either qualitative or quantitative information on the composition of the nanomaterial. It may be that processing the plurality of property measurements generates comparable plottable data (e.g. plottable on 1D, 2D or 3D plots) which can provide either qualitative or quantitative information on the composition of the nanomaterial. It may be that the plurality of property measurements are processed by machine learning. The machine learning may be supervised, unsupervised or semi-supervised. The machine learning may be supervised machine learning, e.g. linear regression. The machine learning may be unsupervised machine learning. The machine learning may be Random Forest-based regression or neural networks. It may be that the plurality of property measurements are processed by a dimensionality reduction technique, e.g. a linear dimensionality reduction technique. Linear dimensionality reduction techniques include principal component analysis (PCA), factor analysis (FA), linear discriminant analysis (LDA) and truncated singular value decomposition (SVD). It may be that the linear dimensionality reduction technique is unsupervised. Preferably, the plurality of property measurements are processed by PCA in order to provide qualitative or quantitative information (e.g. qualitative information). The plurality of property measurements may be processed by Random Forest-based regression in order to provide quantitative information. It may be that processing the plurality of property measurements in order to provide either qualitative or quantitative information on the composition of the nanomaterial (e.g. GBM) is carried out on a smart device, e.g. a smartphone.

For the absence of doubt, when processed, the plurality of property measurements collectively provide either qualitative or quantitative information on the composition of the nanomaterial. The qualitative or quantitative information provided will typically be information that could not be provided if only a single portion of a sample of the nanomaterial was contacted with a single responsive probe and a property the responsive probe in the presence of the nanomaterial was measured to provide a single property measurement.

### Machine Learning Model

Machine learning (or a machine learning algorithm) is applied to a data set (i.e. training data) in order to create a machine learning model. The machine learning model can then be applied to a data set (i.e. test data) in order to make predictions about the test data (based on the training data).

In embodiments, the plurality of property measurements are processed by applying a machine learning model to the plurality of property measurements to provide either qualitative or quantitative information on the composition of the nanomaterial. In this scenario, the plurality of property measurements will be test data, i.e. a plurality of test data property measurements.

It may be that the machine learning model is created by applying machine learning to a plurality of training data property measurements. It may be that the plurality of training data property measurements are provided by contacting a plurality of portions of a sample (or samples) of the nanomaterial with a plurality of responsive probes; and measuring a property of each of the responsive probes in the presence of the nanomaterial to provide the plurality of training data property measurements. Machine learning will then be applied to the plurality of training data property measurements to create the machine learning model.

The method of the first aspect of the invention may therefore comprise:
contacting a plurality of portions of a sample (or samples) of the nanomaterial with a plurality of responsive probes;
measuring a property of each of the responsive probes in the presence of the nanomaterial to provide a plurality of training data property measurements;
applying machine learning to the plurality of training data property measurements in order to create a machine learning model;
contacting a plurality of portions of a sample of the nanomaterial with a plurality of responsive probes;
measuring a property of each of the responsive probes in the presence of the nanomaterial to provide a plurality of test data property measurements; and
applying the machine learning model to the plurality of test data property measurements in order to provide either qualitative or quantitative information on the composition of the nanomaterial.

It may be that the plurality of portions of the sample (or samples) of the nanomaterial that ultimately provide the plurality of training data property measurements have a known value for a variable by which the composition of the nanomaterial can be defined. It may be that the plurality of portions of the sample of the nanomaterial that ultimately provide the plurality of test data property measurements have an unknown value for a variable by which the composition of the nanomaterial can be defined.

### Qualitative Information

In certain embodiments, processing the plurality of property measurements provides qualitative information on the composition of the nanomaterial (e.g. the GBM). It may be that the qualitative information is relative qualitative information. It may be that the qualitative information is the degree of similarity of the composition of the nanomaterial to at least one other sample of the nanomaterial. When contacting a plurality of portions of at least two samples (e.g. at least three, four, or five samples) of the nanomaterial with a plurality of responsive probes, the qualitative information may be the degree of similarity of the composition of at least one of the samples to the other samples of the nanomaterial.

Without wishing to be bound by theory, it is thought that the composition of nanomaterials (e.g. GBMs) effects the degree to which the responsive probes interact with that nanomaterial sample. This gives rise to a shift in the measurable property of the probe, e.g. intensity of fluorescence at a particular wavelength, with stronger interactions typically giving rise to larger shifts and weaker interactions giving rise to smaller shifts. However, different probes will not respond in the same way to differences in the composition of the nanomaterial. Therefore, when an array of probes are in contact with a plurality of portions of a nanomaterial sample a “fingerprint” of different shifts in the measurable property is generated. Similarly, a given probe and a nanomaterial may interact differently under different conditions, e.g. pH or ionic strength. Again, the resultant variation will differ according to the nanomaterial composition. Thus, a fingerprint can still be generated using a smaller number of probes but contacting them with a nanomaterial under different conditions. The plurality of property measurements can then be processed, e.g. by PCA, to compare qualitatively the compositions of different nanomaterial (e.g. GBM) samples.

The method of the present invention may therefore be used to determine how similar different nanomaterial (e.g. GBM) batches are to one another, e.g. batches manufactured by a particular process or batches obtained from a particular supplier.

### Quantitative Information

In certain embodiments, processing the plurality of property measurements provides quantitative information on the composition of the nanomaterial (e.g. the GBM).

It may be that the quantitative information is an estimated value for a variable by which the composition of nanomaterials (e.g. GBMs) can be defined and the estimated value is provided by determining the degree of similarity of the composition of the nanomaterial to at least one sample of the nanomaterial having a known value for that variable.

It may be that the quantitative information is an estimated value for a variable by which the composition of nanomaterials (e.g. GBMs) can be defined and the estimated value is provided by determining the degree of similarity of the composition of the nanomaterial to at least two samples of the nanomaterial having a known value for that variable.

The method may be a method for providing an estimated value for a variable by which the composition of nanomaterials can be defined of a nanomaterial having an unknown value for that variable. It may be that the method comprises:
contacting a plurality of portions of at least three samples of the nanomaterial with a plurality of responsive probes, wherein at least two samples of the nanomaterial have different, known values for the variable, and at least one sample of the nanomaterial has an unknown value for the variable;
measuring a property of each of the responsive probes in the presence of the at least three samples of the nanomaterial to provide a plurality of property measurements; and
processing the plurality of property measurements in order to provide quantitative information on at least one sample of the nanomaterial having an unknown value for the variable (wherein the quantitative information is an estimated value for the variable and the estimated value is provided by determining the degree of similarity of the composition of the at least one sample of the nanomaterial that has an unknown value for the variable to the composition of the at least two samples of the nanomaterial having a known value for that variable).

It may be that the method comprises:
contacting a plurality of portions of at least two samples of the nanomaterial with a plurality of responsive probes, wherein the at least two samples of the nanomaterial have different, known values for the variable;
measuring a property of each of the responsive probes in the presence of the at least two samples of the nanomaterial to provide a plurality of property measurements;
processing the plurality of property measurements in order to provide reference data on the composition of the at least two samples of the nanomaterial;
contacting a plurality of portions of a sample of the nanomaterial having an unknown value for the variable with the plurality of responsive probes;
measuring a property of each of the responsive probes in the presence of the nanomaterial to provide a plurality of property measurements;
processing the plurality of property measurements in order to provide data on the composition of the nanomaterial; and
comparing the data on the composition of the nanomaterial (having an unknown value for the variable) with the reference data in order to provide an estimated value for the variable of the nanomaterial.

It may be that the method comprises contacting a plurality of portions of at least three samples of the nanomaterial with a plurality of responsive probes, wherein the at least three samples of the nanomaterial have different, known values for the variable. It may be that the method comprises contacting a plurality of portions of at least four samples of the nanomaterial with a plurality of responsive probes, wherein the at least four samples of the nanomaterial have different, known values for the variable.

It may be that the reference data is plotted to provide a linear trend line and the data on the composition of the nanomaterial maybe compared to the linear trend line in order to provide the estimated value.

Variables by which the composition of nanomaterials (e.g. GBMs) can be defined include, but are not limited to, the surface area of the nanomaterial, the degree of functionalisation of the nanomaterial (e.g. oxygen content), the degree of sp³ hybridisation of the nanomaterial, the amount of defects in the nanomaterial, and the thickness of the nanomaterial. It may be that the nanomaterial is graphene oxide and the variable is the degree of oxygen containing group modification (e.g. the degree of hydroxy group acetylation).

### Kit

In accordance with the second aspect of the present invention is provided a kit, the kit comprising:
a plurality of responsive probe solutions that differ in at least one characteristic selected from:
i) the identity of the responsive probe;
ii) the solvent of the solution;
iii) the pH of the solution; and/or
iv) the ionic strength of the solution; and
software for processing a plurality of measurements of a property of each of the responsive probes in the presence of a nanomaterial (e.g. a GBM) in order to provide either qualitative or quantitative information on the composition of the nanomaterial, or a link, e.g. a hyperlink thereto.

In an embodiment, the kit comprises:
a plurality of responsive probe solutions that differ in at least one characteristic selected from:
i) the identity of the responsive probe;
ii) the solvent of the solution;
iii) the pH of the solution;
iv) the ionic strength of the solution;
v) the concentration of the responsive probe; and/or
vi) the absence or presence of a non-responsive competing binder, and, if present, optionally the concentration of the non-responsive competing binder; and
   software for processing a plurality of measurements of a property of each of the responsive probes in the presence of a nanomaterial (e.g. a GBM) in order to provide either qualitative or quantitative information on the composition of the nanomaterial, or a link, e.g. a hyperlink thereto.

It may be that the plurality of responsive probe solutions consists of 2 or more solutions. It may be that the plurality of responsive probe solutions consists of 3 or more solutions. It may be that the plurality of responsive probe solutions consists of 4 or more solutions. It may be that the plurality of responsive probes solutions consists of 5 or more solutions.

It may be that at least two of the solutions differ in the identity of the responsive probe. It may be that each solution differs in the identity of the responsive probe.

It may be that at least two of the solutions do not differ in the identity of the responsive probe but said solutions differ in at least one characteristic selected from ii) the solvent of the solution; iii) the pH of the solution; and/or iv) the ionic strength of the solution. It may be that none of the solutions differ in the identity of the responsive probe, but said solutions differ in at least one characteristic selected from ii) the solvent of the solution; iii) the pH of the solution; and/or iv) the ionic strength of the solution.

It may be that the solutions comprise solution A and solution B, wherein solution A comprises two responsive probes having different identities and solution B comprises two responsive probes having different identities. It may be that one of the responsive probes in solution A has the same identity as one of the responsive probes in solution B (and the other responsive probe in solution A has a different identity to the other responsive probe in solution B). Alternatively, it may be that neither of the responsive probes in solution A have the same identity of either of the responsive probes in solution B.

It may be that at least one of the solutions comprises a non-responsive competing binder. It may be that the solutions comprise solution C and solution D, wherein solution C comprises a responsive probe and solution D comprises a responsive probe having the same identity as the probe in solution C and a non-responsive competing binder. It may be that the solutions comprise solution E and solution F, wherein solution E comprises a probe and a non-responsive competing binder and solution F comprises a probe having a different identity to the probe in solution E and a non-responsive competing binder having the same identity as the non-responsive competing binder in solution E.

It may be that at least two of the solutions do not differ in the identity of the responsive probe but have different pHs. It may be that none of the solutions differ in the identity of the responsive probe but each solution has a different pH. It may be that the pH of the solutions are each independently selected to be in the range from 6 to 8, e.g. from 6.5 to 7.5. At least one of the solutions (e.g. each solution) may comprise a buffer. The buffer may be a phosphate buffer. The buffer may be a neutral buffer. The buffer may maintain the pH of the solution in the range from 6 to 8, e.g. from 6.5 to 7.5.

The solutions may be aqueous solutions. The solutions may comprise an organic solvent. The organic solvent may be selected from the group consisting of an ether, methanol, ethanol, chloroform, tetrachloromethane, benzene, tetrahydrofuran, dimethyl acetamide, N-Methyl-2-pyrrolidone and DMSO.

At least one of the solutions (e.g. each solution) may comprise a total ionic strength adjustment buffer (TISAB).

It may be that the kit comprises a solution comprising a non-responsive competing binder.

The responsive probes may be as defined above in the first aspect of the invention.

It may be that the software is software for deconvoluting a plurality of measurements of a property of each of the responsive probes in the presence of a nanomaterial (e.g. a GBM) in order to provide either qualitative or quantitative information on the composition of the nanomaterial. It may be that the software for processing the plurality of property measurements generates plottable data (e.g. plottable on 1D, 2D or 3D plots) which can be used to provide either qualitative or quantitative information on the composition of the nanomaterial.

It may be that the software is machine learning software. The machine learning may be supervised, unsupervised or semi-supervised. The machine learning may be supervised machine learning, e.g. the software may be linear regression software. The machine learning may be unsupervised machine learning. The machine learning may be Random Forest-based regression or neural networks. It may be that software is dimensionality reduction technique software, e.g. linear dimensionality reduction technique software. Linear dimensionality reduction techniques include principal component analysis (PCA), factor analysis (FA), linear discriminant analysis (LDA) and truncated singular value decomposition (SVD). It may be that the linear dimensionality reduction technique is unsupervised. In order to provide qualitative information, preferably the software is PCA. In order to provide quantitative information, preferably the software is Random Forest-based regression.

The kit may further comprise at least one sample of a nanomaterial (e.g. a GBM) having a known value for a variable by which the composition of nanomaterials can be defined. Variables by which the composition of nanomaterials (e.g. GBMs) can be defined include, but are not limited to, the surface area of the nanomaterial, the degree of functionalisation of the nanomaterial (e.g. oxygen content), the degree of sp³ hybridisation of the nanomaterial, the amount of defects in the nanomaterial, and the thickness of the nanomaterial.

It may be that the kit further comprises a buffer solution. The buffer may be a phosphate buffer. The buffer may be a neutral buffer. It may be that the kit further comprises a plurality of buffer solutions.

The kit may further comprise a microplate, e.g. a 96-well microplate. The kit may further comprise a pipette. The kit may further comprise instructions on how to use the kit to obtain information on the composition of a nanomaterial (e.g. a GBM), e.g. the instructions may outline a method according to the first aspect of the invention.

It may be that the kit is for carrying out a method according to the first aspect of the invention.

### BRIEF DESCRIPTION OF THE DRAWINGS

Embodiments of the invention are further described hereinafter with reference to the accompanying drawings, in which:

FIG. 1 is an exemplary workflow of a method according to the present invention comprising steps a) to f): a) GO Samples and probes are combined in well plates; b) emission spectra for each sample is obtained by using a well plate fluorescence spectrophotometer; c) spectra data is exported from the instrument; d) intensities for the desired wavelengths for each probe are collated; e) the collated data is scaled then analysed with PCA using the sklearn module on Python (code found in SI); and f) the output data from the PCA analysis is collected and this data is used to construct 2D PCA plots (g).

FIG. 2a is a table showing the raw data which lead to the plot of FIG. 2b.

FIG. 2b shows the result of PCA on the measured responses of Probes 1 to 4 with GO samples GO(a) to GO(d) in water. Input values for the PCA. The six different data points for each GO represents six wells of the same composition. Variance between the data points is likely due to pipetting error and/or the surface tension of small amounts of sample in small wells (above). The PCA plot shows the separation of each GO sample, with the variance of each principal component (PC) account denoted in brackets. The dashed lines denote a 95% confidence ellipse for each GO sample (below).

FIG. 3 shows the result of PCA on the measured responses of Probes 1 to 4 with GO samples GO(a) to GO(d) in phosphate buffer. Th dashed ellipses denote a 95% confidence region for each GO sample. The commercial GO(a) is well separated from the non-commercial GO samples.

FIG. 4 shows the result of PCA on the measured responses of Probes 1 to 5 with GO samples GO(a) to GO(d) in phosphate buffer. The addition of a fifth probe did not significantly change the contributions of each PC, suggesting that Probe 5 has a similar binding to another probe used, likely Probe 1.

FIG. 5 shows the result of PCA on the measured responses of Probes 1 to 5 with GO samples GO(a) to GO(d) in phosphate buffer, with different concentrations of GO(a). The dashed ellipses denote a 95% confidence region. The lower concentrations of GO(a) did not occupy the part of the plot that the non-commercial GO samples occupy, suggesting an inherent difference between GO(a) and the other GO samples.

FIG. 6 shows the result of PCA on the measured responses of Probes 1 to 5 with GO samples GO(a) to GO(f) in phosphate buffer. The dashed ellipses denote 95% confidence regions for each sample, but the black dashed ellipse represents a 95% confidence region for GO(b), GO(c), and GO(d) combined. The commercial GO samples GO(a), GO(e), and GO(f) were well separated, while the three similar GO samples GO(b), GO(c) and GO(d) remain in their own cluster.

FIG. 7 shows the result of PCA on the measured response of Probes 1 to 5 with GO samples GO(g) to GO(k) in distilled water.

FIG. 8 shows a linear plot of the average PC1 value of PCA on the measured response of Probes 1 to 5 with GO samples GO(g) to GO(j) in distilled water against the degree of surface modification. The average PC1 value of PCA on the measured response of Probes 1 to 5 with GO sample GO(k) has been added to the plot in order to provide quantitative information (i.e. the estimated degree of surface modification) on GO sample GO(k).

### DETAILED DESCRIPTION

The term ‘nanomaterial’ is intended to cover any material having at least one nanoscopic dimension, ‘nanoscopic’ being from 1-100 nanometers. Nanomaterials can be broadly classified by the total number of their nanoscopic dimensions as seen in the following Table 1:

TABLE 1

| Number of Nanoscopic | |
|---|---|
| Dimensions | Classification |
| 0 | Bulk (not a nanomaterial) |
| 1 | 2D (nanosheet) |
| 2 | 1D (nanotubes, nanowires, nanorods) |
| 3 | 0D (nanoparticle) |

Graphene is the name given to a flat sheet, e.g. a flat monolayer, of sp²-hybridised carbon atoms tightly packed into a two-dimensional (2D) honeycomb lattice. Typically, graphene consists of 10 layers or less stacked on top of each other.

The term “graphene-based material (GBM)” is intended to cover graphene and derivatives of graphene that are substantially sp² hybridised in character and adopt a flat, planar or stacked structure. For the absence of doubt, the term “graphene-based material” is also intended cover materials comprising >10 layers of graphene stacked on top of each other, i.e. graphite and derivatives. Graphene based materials include, but are not limited to, graphene, e.g., pristine graphene, graphene oxide, reduced graphene oxide, functionalised graphene and doped graphene, graphite and graphite oxide.

A “responsive probe” is a chemical entity that has a measurable property, e.g. fluorescence, and that can interact with a nanomaterial (e.g. a GBM) to bring about a change in that measurable property. An example of a measurable property of a responsive probe is the extent to which that probe can absorb, emit, and/or reflect electromagnetic radiation, e.g. infrared radiation, visible light, ultraviolet radiation and X-rays. Other measurable properties of a responsive probe includes nuclear magnetic resonance and electrochemical properties, e.g. electrochemical potential or electrochemical impedance.

A “non-responsive competing binder” is a chemical entity that does not have a measurable property, or that has measurable property different to that of the responsive probes, but that may still interact with a nanomaterial. The non-responsive competing binder may therefore affect the extent to which a nanomaterial brings about a change in the measurable property of a responsive probe. The non-responsive competing binder may be a small molecule (i.e. a molecule (or salt thereof) having a molecular mass below 5000 gmol⁻¹. Macromolecular non-responsive competing binders may also have use in the present invention, such as polymers (e.g. poly(sodium 4-styenesulfonate)), conjugated polymers and biopolymers. The non-responsive competing binder may be a metal complex.

The responsive probe (and if present, non-responsive competing binder) may interact with the nanomaterial (e.g. the GBM) via an intermolecular attraction or attractions, e.g. hydrogen bonding and/or Van der Waals forces. Alternatively, the responsive probes (and if present, non-responsive competing binder) may interact with the nanomaterial via the formation of covalent or dative bonds.

A “dispersion” is a system in which nanomaterial particles are dispersed (suspended) in a liquid phase (the phase being liquid at room temperature). The liquid phase is typically a solvent.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

### EXAMPLES

Throughout this specification these abbreviations have the following meanings:

| | | | |
|---|---|---|---|
| GO | graphene oxide | EtOH | ethanol |
| HSQC | heteronuclear single | s | seconds |
| | quantum coherence | | |
| COSY | homonuclear correlation | PCA | principal component |
| | spectroscopy | | analysis |
| DEPT | distortionless enhancement by | PC | principal component |
| | polarization transfer | | |
| eq | equivalents | h | hour |

The structures of the probes used in the examples can be seen in Table 2.

TABLE 2

| | |
|---|---|
| 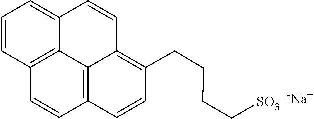 | Probe 1 |
| 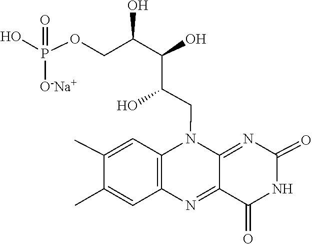 | Probe 2 |
| 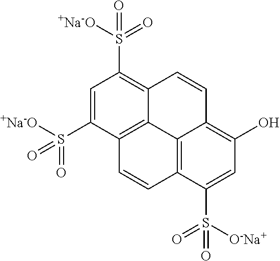 | Probe 3 |
| 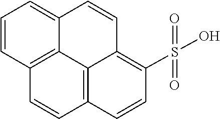 [SMILES: O=S(=O)(O)c1ccc2ccc3cccc4ccc1c2c34] | Probe 4 |
| 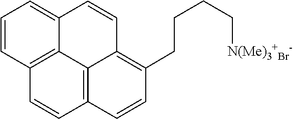 | Probe 5 |

Details of the graphene oxide samples used in the examples can be seen in Table 3.

TABLE 3

| Identity | Source | Comments |
|---|---|---|
| GO(a) | Commercial | 15-20 sheets, 4-10% edge oxidised |
| | (Sigma Aldrich) | |
| GO(b) | Academic institute | Supplied from the same source but treated |
| GO(c) | | differently (different dissolution, |
| GO(d) | | freeze drying cycles) |
| GO(e) | Commercial | >90% monolayer content, 0.5-5 μm |
| | (Graphitene) | lateral size, 55-65% C, 35-45% O |
| GO(f) | Commercial | Variable sheet size, 60-70% C, >30% O |
| | (GOGraphene) | |
| GO(g) | Commerical | “0% modified”: commercially-available |
| | (William Blythe) | sample which may be considered 0% |
| | | modified for |
| | | quantification of surface modification. |
| | | Bought as “5 G Graphene Oxide Powder” |
| | | (Product code JC05-184GP). |
| GO(h) | Modification of | “19% modified” |
| | GO(g) | |
| GO(i) | Modification of | “29% modified” |
| | GO(g) | |
| GO(j) | Modification of | “47% modified” |
| | GO(g) | |
| GO(k) | Modification of | Sample with unknown surface |
| | GO(g) | modification to be quantified |

### Materials and Methods

1-pyrenebutanol, 1-pyrenesulfonic acid (Probe 4) and the graphene oxide sample GO(a) was obtained commercially from Sigma-Aldrich. Pyranine (Probe 3) was obtained commercially from Alfa Aesar. Riboflavin 5′-monophosphate (Probe 2) was obtained commercially from Fluorochem. Graphene oxide samples GO(b), GO(c) and GO(d) were provided by an academic institute. The graphene oxide sample GO(e) was obtained commercially from Graphitene and GO(f) was obtained commercially from GOGraphene. Deionised water (18.2 MΩ cm) was used throughout.

Samples GO(h) to GO(k) were produced by modification of a commercially-obtained sample GO(g) by a modification of methods reported in A. Talyzin et al., Phys.Chem.Chem.Phys, 2020, 22, 21059-21067.

Graphene oxide (50 mg), anhydrous pyridine (5 mL) and varying amounts of dry acetic anhydride (from 80 μL to 2 mL, depending on the desired degree of surface modification) was added to a 20 mL vial under a nitrogen atmosphere. The reaction mixture was stirred at 60° C. for different times (1 h to 1 week, depending on the desired degree of surface modification). The amount of acetic anhydride and mixing time to achieve different degrees of surface modification for samples GO(h) to GO(k) can be seen in Table 4.

TABLE 4

| | Acetic anhydride | | | | |
|---|---|---|---|---|---|
| Identity | volume | | Reaction time | | Degree of modification |
| GO(h) | 80 | μL | 1 | week | “19% modified” |
| GO(i) | 165 | μL | 5 | hours | “29% modified” |
| GO(j) | 2 | mL | 1 | hours | “47% modified” |
| GO(k) | 165 | μL | 24 | hours | Sample with unknown |
| | | | | | surface modification |
| | | | | | to be quantified |
| | | | | | (known to be 38% |
| | | | | | modified, by Rao |
| | | | | | et al.) |

Each mixture was filtered with diethyl ether followed by: (i) several cycles of washing with warm methanol; (ii) four cycles of washing with water; and (iii) centrifugation (30 min at 4000 rpm). Samples were then dried in a freeze-drier for two days to produce fine powder samples.

The degree of modification (i.e. the percentage of acetylated OH groups on the surface of the GO) was determined using a separate established method (reported by C.N.R. Rao et al., Chem. Phys., 2017, 683, 459-466), independent of the well-plate assay. Briefly, an activated fluorescent molecule, 1-(bromoacetyl) pyrene, is allowed to react with any remaining (non-acetylated) alcohol groups on the surface of the material. Unreacted 1-(bromoacetyl)pyrene may be determined by spectrofluorimetric analysis, and hence the number of unmodified alcohol groups. Comparison to the amount of unmodified alcohol groups in the original material, GO(g), allows the degree of surface modification to be quantified.

Well-plate fluorescence studies were performed using a BioTek Cytation 5 Cell Imaging Multi Mode Reader.

### Synthesis of Compound 1, Probe 1 and Probe 5

The synthesis of Compound 1, Probe 1 and Probe 5 is outlined in the scheme below.

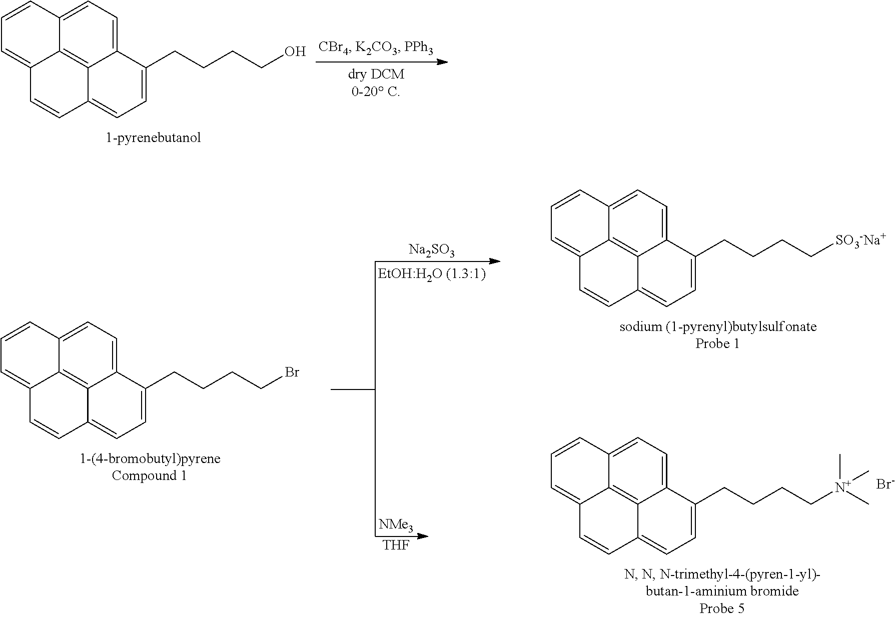

### Synthesis of 1-(4-bromobutyl)pyrene (Compound 1)

Compound 1 was made according to the process disclosed in K. W. J. Heard, at al., ACS Omega, 2019, 4, 1969-1981.

### Synthesis of Sodium (1-pyrenyl)butylsulfonate (Probe 1)

Probe 1 was made according to the process disclosed in K. W. J. Heard, at al., ACS Omega, 2019, 4, 1969-1981.

### Synthesis of N,N,N-trimethyl-4-(pyren-1-yl)-butan-1-aminium bromide (Probe 5)

Probe 5 was made according to the process disclosed in M. S. Becherer, et al., Chem. Eur. J., 2009, 15, 1637-1648.

### Assay Design

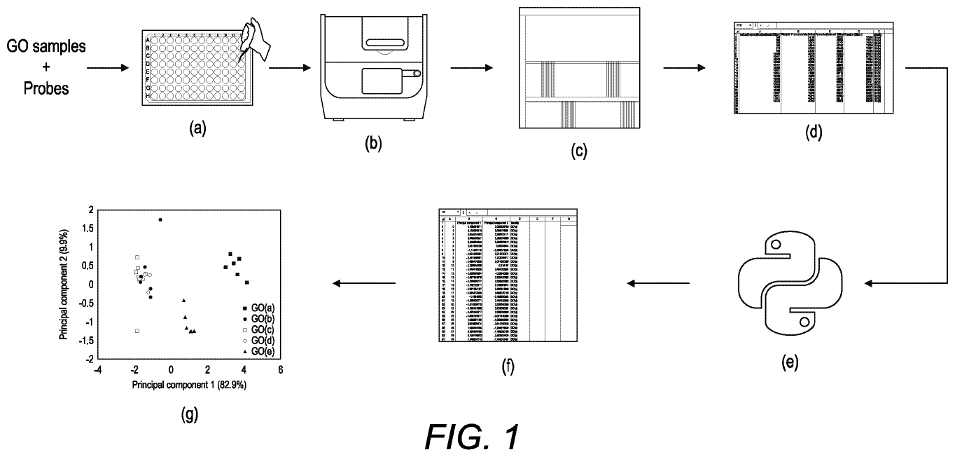

FIG. 1 shows the workflow on which the following exemplary assay were based on.

Method A, Well Plate Fluorescence Study: Initially, 0.1 mg/ml of each probe in distilled water was added to 0.1 mg/ml of each graphene oxide sample in distilled water in varying volumes in a well plate well to total 40 μL. The GO samples were sonicated for 30 s before addition. This plate was then analysed in a fluorescence plate reader (Assay 1). A variation of this method was then used for further analysis, using 33 μL of 1 mM concentrations of each probe in either distilled water or 0.2 M pH 7.0 phosphate buffer, with 40 μL of 0.01 mg/mL GO sample (Assays 2-5).

Method A, Data Analysis: The excitation wavelengths for each probe and the wavelengths of interest in the emission spectra from which the intensity values are obtained can be seen in Table 5.

TABLE 5

| | | Wavelength of interest for emission |
|---|---|---|
| Probe | λ_{exc} (nm) | intensities (nm) |
| 1 | 270 | 380 |
| 2 | 449 | 540 |
| 3 | 350 | 395 |
| 4 | 454 | 520 |
| 5 | 270 | 400 |

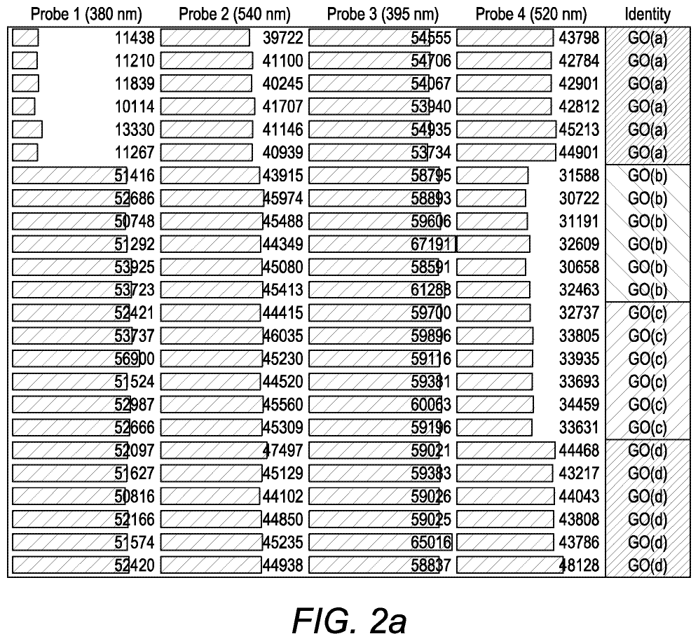

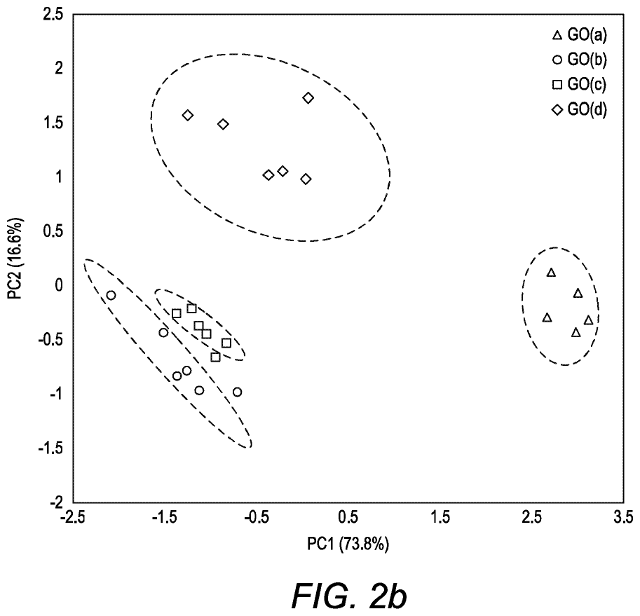

The intensities of each sample at the wavelength of interest for the relevant probe in the sample were collated. Intensity data was collected by exciting each probe around their absorbance maximum wavelength, and collecting emission intensity around their emission maximum wavelength. This data may be tabulated, e.g. as can be seen in FIG. 2a.

This multivariate data was processed to yield a 2-dimensional plot, which is indicative of the nature of the GO being characterised. For example, for FIG. 2b, the data in the table of FIG. 2a was subjected to standard principal component analysis (PCA). PCA is a standard approach, and may be achieved by using a range of standard tools. The data in the table of FIG. 2a was subject to PCA using the scikit-learn library in the Python environment. Following PCA, the output data was exported to Excel, and plotted on a 2D plot. Principal components (PCs) are plotted, e.g. in FIG. 2 the first two PCs were plotted. Typically these are labelled with the percentage of raw data variance explained by each PC, e.g. in FIG. 2 PC1 explains 73.8% observed in the raw data. Repeat analysis may be averaged, to indicate experimental error, e.g. in FIG. 2b an ellipse was drawn around the mean average of all the analyses of a particular GO sample (using the Excel Add-In XRealStats) representing a 95% confidence limit. Position of different samples on the resulting output plot (e.g. FIG. 2b) provides a readout of the nature of the GO sample.

Method B, Well Plate Fluorescence Study: 127 μL of distilled water and 33 μL of each solution probe (0.1 mM in distilled water) was added to 40 μL of each graphene oxide modified (suspension 0.1 mg/mL in distilled water) in a well plate well to total 200 μL. The GO-modified samples were sonicated for 30 s and left rest 15 min before addition. This plate was then analysed in a fluorescence plate reader.

Excitation wavelengths and data treatment proceeded as in Method A, except that ellipses drawn in PCA plot to represent 95% confidence limit were produced in Excel using the XLSTAT Add-In.

### Method A was used for Assays 1-5. Method B was used for Assay 6.

### Assay 1

Probes 1 to 4 were added with GO(a) to GO(d). The fluorescence intensity of each well was recorded, with the values then analysed using PCA. This PCA resulted in the separation of GO(a) and GO(d), while GO(b) and GO(c) were not as well separated. As GO(b), GO(c), and GO(d) were obtained from the same source (FIG. 2b), it was expected that these three samples would be in clusters, but this was only found with GO(b) and GO(c).

### Assay 2

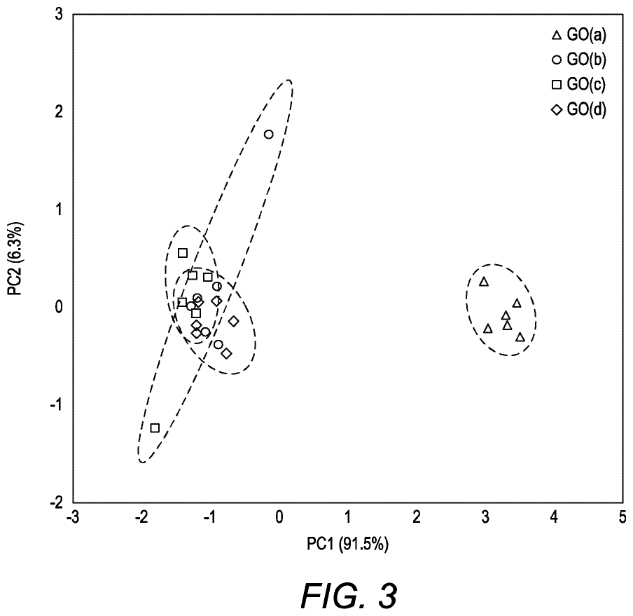

To investigate whether pH has a significant effect on probe binding, the same analysis was then performed using a 0.2 M pH 7.0 phosphate buffer (FIG. 3). The change in the position in two dimensions by GO(d) suggests that pH does influence the binding and therefore separation of the samples in PCA. The buffered system showed results more in line with expected results, with GO(b), GO(c) and GO(d) being in one cluster. GO(a) remains well-separated from the other GO samples, suggesting GO(a) is inherently different to the other samples. As pH looked to have a significant impact on binding, all subsequent assays used this buffered system to mitigate the effects of this variable.

### Assay 3

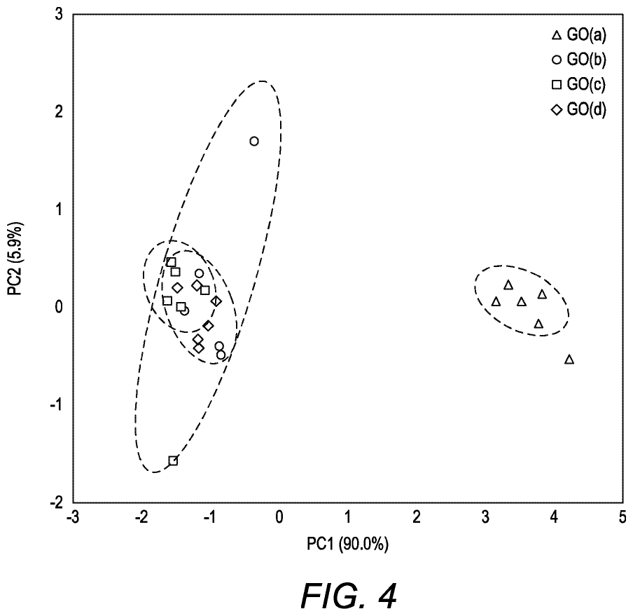

To establish whether the addition of a fifth probe would significantly change the separation, the GO samples were combined with Probe 5, with the data then used to append the data of the previous experiment (FIG. 4). PCs 1 and 2 accounting for a lower percentage of variance than the data from 4 probes was observed. However, as the exact nature of future GO samples are unknown, the positively charged nature of Probe 5 may have a substantial effect and therefore it was decided to keep Probe 5 to add probe diversity.

### Assay 4

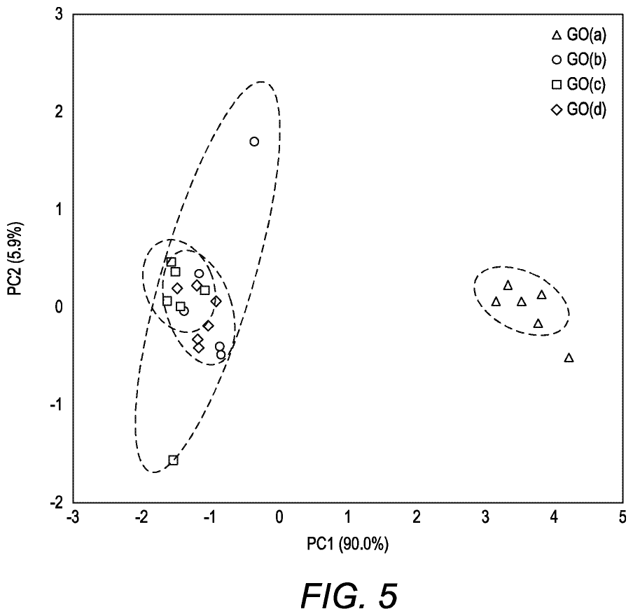

To determine if the difference observed is due to miscalculation/small differences in concentration, varying concentrations of GO(a) was analysed along with original concentrations of GO(b) to GO(d) (FIG. 5). The results showed that the half and quarter concentrations of GO(a) did not occupy the same cluster as GO(b) to GO(d), suggesting that concentration is only one factor that influences the results.

### Assay 5

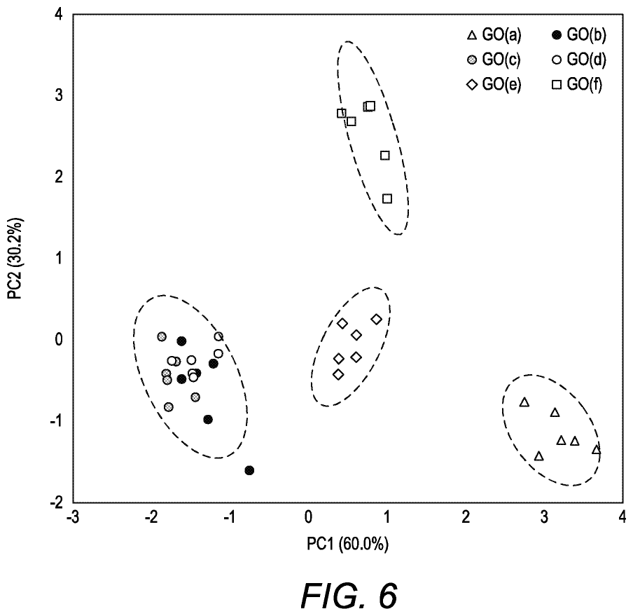

GO(e) and GO(f) samples were analysed. The PCA plot shows that each of these two samples occupy distinct regions in space compared to the other GOs (FIG. 6).

All the commercial samples were individually resolved, as well as being clearly resolved from the non-commercial samples. Each of the non-commercial samples, which were thought of as similar, were not resolved by this PCA.

### Assay 6

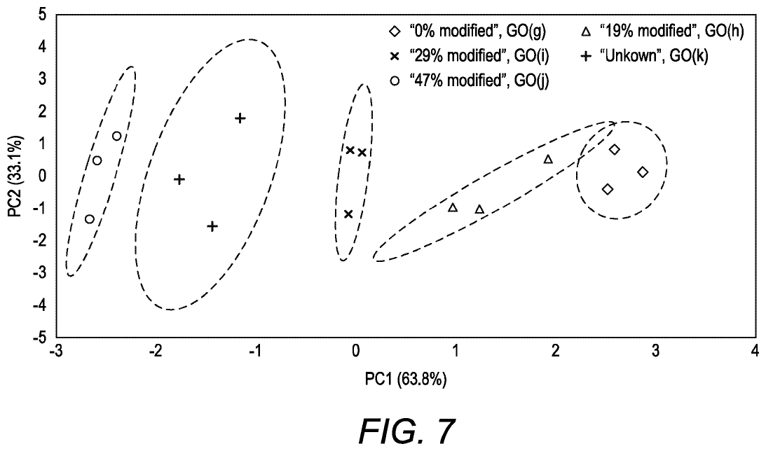

Samples GO(g) to GO(k) were analysed according to Method B. The resulting PCA plot shows a systematic variation, following the samples' degree of surface modification (FIG. 7).

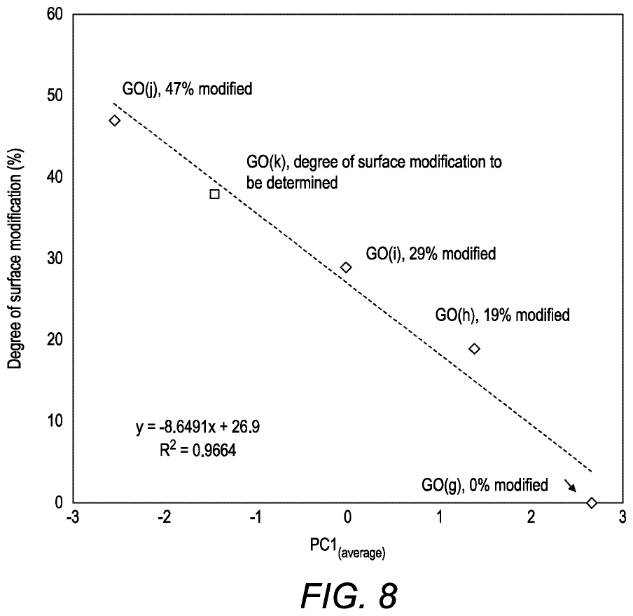

A linear plot of the PC1 of samples GO(g) to GO(j) (taken as the average for all analytical repetitions of a sample) against degree of surface modification shows a systematic relationship, suitable for quantification of the degree of surface modification (FIG. 8).

As an example of quantification, plotting the average of PC1 determined for samples GO(g) to GO(j) against the degrees of surface modification allows a linear relationship to be observed (as in FIG. 8). Linear regression (using Excel, see plot) provides a formula which may be used to quantify the degree of surface modification where it is not already known. Applying this linear relationship to the average of PC1 determined for sample GO(k),−1.45675, we can quantify the degree of modification to be 39.5% (as follows: % Modification=−8.6491 (PC1_{(average)}+26.9). Independently, the % surface modification for GO(k) had been determined to be 38% (using the method reported by C.N.R. Rao et al., Chem. Phys., 2017, 683, 459-466), confirming our quantification of surface modification (error under 5%).

1. A method for providing information on the composition of a nanomaterial, the method comprising:
contacting a plurality of portions of a sample of the nanomaterial with a plurality of responsive probes;
measuring a property of each of the responsive probes in the presence of the nanomaterial to provide a plurality of property measurements; and
processing the plurality of property measurements in order to provide either qualitative or quantitative information on the composition of the nanomaterial.

2. The method of claim 1, wherein processing the plurality of property measurements provides qualitative information on the composition of the nanomaterial.

3. The method of claim 2, wherein the qualitative information is the degree of similarity of the composition of the nanomaterial to at least one other sample of the nanomaterial.

4. The method of claim 1, wherein processing the plurality of property measurements provides quantitative information on the composition of the nanomaterial.

5. The method of claim 4, wherein the quantitative information is an estimated value for a variable by which the composition of a nanomaterial can be defined and the estimated value is provided by determining the degree of similarity of the composition of the nanomaterial to at least one sample of the nanomaterial having a known value for that variable.

6. The method of claim 1, wherein principal component analysis is used to process the plurality of property measurements.

7. The method of claim 1, wherein the plurality of probes consists of 4 or more responsive probes.

8. The method of claim 7, wherein the plurality of probes consists of 5 or more responsive probes.

9. The method of claim 1, wherein the responsive probes are fluorescent probes and the property of each of the responsive probes in the presence of the nanomaterial is fluorescence.

10. The method of claim 9, wherein the array of probes comprises an amphiphilic probe and/or wherein the array of probes comprises a probe comprising an aromatic moiety and a charged or dipolar moiety.

11. (canceled)

12. The method of claim 10, wherein the probe comprising an aromatic moiety and a charged or dipolar moiety further comprises a hydrocarbon spacer linking the aromatic moiety to the charged or dipolar moiety.

13. The method of claim 9, wherein the array of fluorescent probes comprises at least one probe selected from:

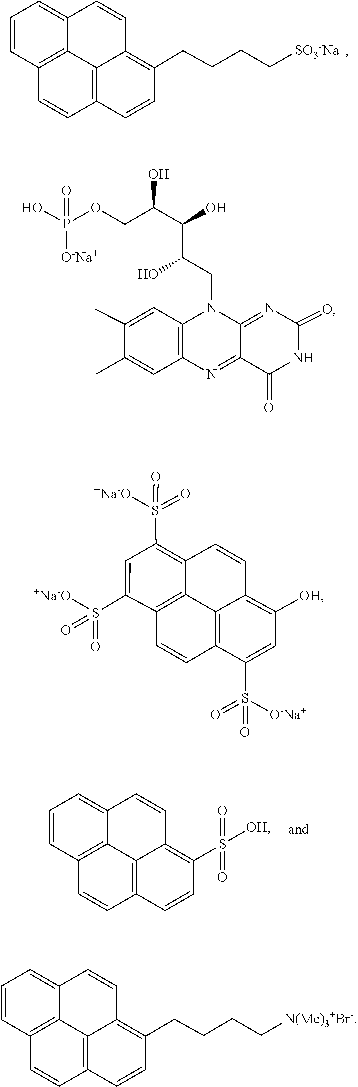

14. The method of claim 1, wherein the responsive probes are ultraviolet-visible probes and the property of each of the responsive probes in the presence of the nanomaterial is the absorbance and/or emission of light in the UV-visible range.

15. The method of claim 1, wherein the portions of the sample of the nanomaterial are dispersions of the nanomaterial.

16. The method of claim 15, wherein the dispersions are aqueous dispersions and/or wherein the dispersions comprise a buffer.

17. (canceled)

18. The method of claim 1, wherein the nanomaterial is a graphene-based material.

19. The method of claim 18, wherein the graphene-based material is graphene.

20. The method of claim 18, wherein the graphene-based material is graphene oxide or reduced graphene oxide.

21. (canceled)

22. A kit, the kit comprising:
a plurality of responsive probe solutions that differ in at least one characteristic selected from:
i) the identity of the responsive probe;
ii) the solvent of the solution;
iii) the pH of the solution; and/or
iv) the ionic strength of the solution; and
software for processing a plurality of measurements of a property of each of the responsive probes in the presence of a graphene-based material in order to provide either qualitative or quantitative information on the composition of the graphene-based material, or a link thereto.

23. The kit of claim 22, wherein the plurality of responsive probe solutions differ in at least one characteristic selected from i) to iv) and/or:
v) the absence or presence of a non-responsive competing binder, and, if present, optionally the concentration of the non-responsive competing binder.
